(19) United States
(12) Patent Application Publication
(10) Pub. No.: US 2012/0086393 A1
(43) Pub. Date: Apr. 12, 2012

(54) Device and Method for an Intermittent Load

(75) Inventors: Richard Landry Gray, Saratoga, CA (US); Po Ming Tsai, Taipei (TW)

(73) Assignee: Richard Landry Gray, Saratoga, CA (US)

(21) Appl. No.: 13/267,908

(22) Filed: Oct. 7, 2011

Related U.S. Application Data
(60) Provisional application No. 61/391,095, filed on Oct. 8, 2010.

(51) Int. Cl. H02J 7/04

(52) U.S. Cl. 320/108

(57) ABSTRACT

An approach is provided for minimizing capacitance requirements of a filter capacitor of a charging device for an intermittent load. A method for charging an intermittent load that is able to pulse on and off periodically without compromising the utility of the load. The method comprises setting timestamps relating to a waveform of an input Alternating Current (AC) voltage. The timestamps are synchronized to the AC voltage and comprise on times and off times that turn the intermittent load off and on. The method further comprises charging the intermittent load during the on times. Therefore, the capacitance of the filter capacitor used for the intermittent load can be significantly reduced since there will be no voltage drop when the intermittent load has been turned off.

This application claims priority benefit under 35 USC 119 of provisional patent application Ser. No. 61/391,095, filed 8 Oct. 2010.

### FIELD OF THE INVENTION

Embodiments of the invention relate to power management, and more particularly, to provide an intermittent load charging method and a charging device in response to Alternating Current (AC) signals of a power source.

### BACKGROUND

Many electronic devices driven from Alternating Current (AC) voltage (i.e. line voltage) have a filtering stage consisting of a diode rectifier and a filter capacitor. The rectifier provides a pulsating Direct Current (DC) voltage. The filter capacitor must be able to withstand the high rectified voltage and hold enough charge to supply the load with current when the incoming AC voltage approaches zero volts. In general, electrolytic capacitors are used as the filter capacitor due to their characteristically high voltage rating, large capacitance value and reasonable cost.

With reference to FIG. 1 as an example, FIG. 1 illustrates a conventional primary side battery charging scheme for a lithium-ion (Li-ion) battery charger using a large capacity electrolytic capacitor. The Li-ion battery charger comprises a filtering stage 10, a primary side controller 11, and a flyback converter 12. The filtering stage 10 comprises a rectifier 101 and a filter capacitor 102. The rectifier 101 connects to an AC voltage power source 13, which converts an AC voltage to a pulsating DC voltage. The filter capacitor 102 is an electrolytic capacitor and is connected to the rectifier 101 for sustaining voltages when the pulsating DC voltage approaches zero. The primary side controller 11 connects to the filter capacitor 102 and provides a regulating charging control in response to voltages of the filter capacitor 102. The flyback converter 12 is connected to the filter capacitor 102, the primary side controller 11 and a Li-ion battery 14. The flyback converter 12 comprises output means for accepting the Li-ion battery 14 in order that it may be charged.

Unfortunately, electrolytic capacitors suffer from short lifetimes, especially when exposed to elevated temperatures. In fact, the major factor limiting the lifetime of many electronic devices is the lifetime of the electrolytic filter capacitor. If the electrolytic filter capacitor could be replaced with a longer lived capacitor technology, such as polyester film, ceramic or Mylar, then the lifetime of the electronic devices could be significantly extended resulting in less electronic waste and a lower burden on our planet's resources.

However, the existing longer lived capacitor technologies are usually, for a given capacitance value, more expensive and physically larger than their electrolytic counterparts. Therefore, there is a need for an approach to provide a means or a mechanism that can be adapted to electronic devices for lowering the capacitance requirement for the filter capacitor so that it could easily be replaced by one of the more reliable alternatives (i.e. longer lived capacitors).

### SOME EXEMPLARY EMBODIMENTS

These and other needs are addressed by the invention, wherein an approach is provided for minimizing capacitance requirements of a filter capacitor (e.g. eliminating the need for an electrolytic capacitor) of a charging device for an intermittent load.

According to one aspect of an embodiment of the invention, a method for charging an intermittent load that is able to pulse on and off periodically without compromising the utility of the load. The method comprises setting timestamps relating to a waveform of an input Alternating Current (AC) voltage. The timestamps are synchronized to the AC voltage and comprise on times and off times that turn the intermittent load off and on. The method further comprises charging the intermittent load during the on times.

According to another aspect of an embodiment of the invention, a method for charging a Lithium-ion (Li-ion) cell comprises setting timestamps relating to a waveform of an input AC voltage. The timestamps are synchronized to the AC voltage and have on times and off times. The method for charging a Li-ion cell further comprises charging the Li-ion cell during the on times, and turning off the Li-ion cell for charging during the off times. The method of charging the Li-ion cell during the on times further comprising providing constant current pulses but voltages of the current pulses increasing in value until a predetermined threshold voltage, and providing constant voltage pulses whose current gradually decreases until a predetermined low current value.

According to another aspect of an embodiment of the invention, an intermittent load charging device comprises a filtering stage, a converter, an intermittent controller, and a charging controller. The filtering stage comprises a rectifier and a filter capacitor. The rectifier connects to an AC voltage power source and converts an AC voltage to a pulsating DC voltage. The filter capacitor is connected to the rectifier for sustaining voltages when the pulsating DC voltage approaches zero. The converter is connected to the filter capacitor and an intermittent load, and has output means for accepting the intermittent load to be charged. The intermittent controller is connected to the AC voltage power source and the rectifier, and generates an interrupt signal that is synchronized with the AC voltage. The charging controller is connected to the filter capacitor, the converter and the intermittent controller. The charging controller provides a regulating charging control for the converter, and accepts the interrupt signal from the intermittent controller that turns the intermittent load on and off.

The intermittent load can be a Li-ion battery or other load that can be pulsed on and off periodically without compromising its utility.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a conventional primary side battery charging circuit for a lithium-ion (Li-ion) battery charger using a large capacity electrolytic capacitor;

FIG. 2a is a flow chart of a method for charging an intermittent load in accordance with an embodiment of the present invention;

FIG. 2b is a flow chart of the step S201 of FIG. 2a for charging an intermittent load in accordance with an embodiment of the present invention;

FIG. 3 is an exemplary waveform diagram of an intermittent load in response to a rectified Alternating Current (AC) voltage and its current, in accordance with another embodiment of the present invention;

FIG. 4a is a flow chart of a method for charging a Lithium-ion (Li-ion) cell in accordance with an embodiment of the present invention;

FIG. 4b is an flow chart of the step S402 of FIG. 4a for charging a Li-ion cell in accordance with an embodiment of the present invention;

FIG. 5 is an exemplary diagram of a typical charging curve for a Li-ion cell; and

FIG. 6 is an exemplary circuit diagram of a charging device in accordance with an embodiment of the present invention.

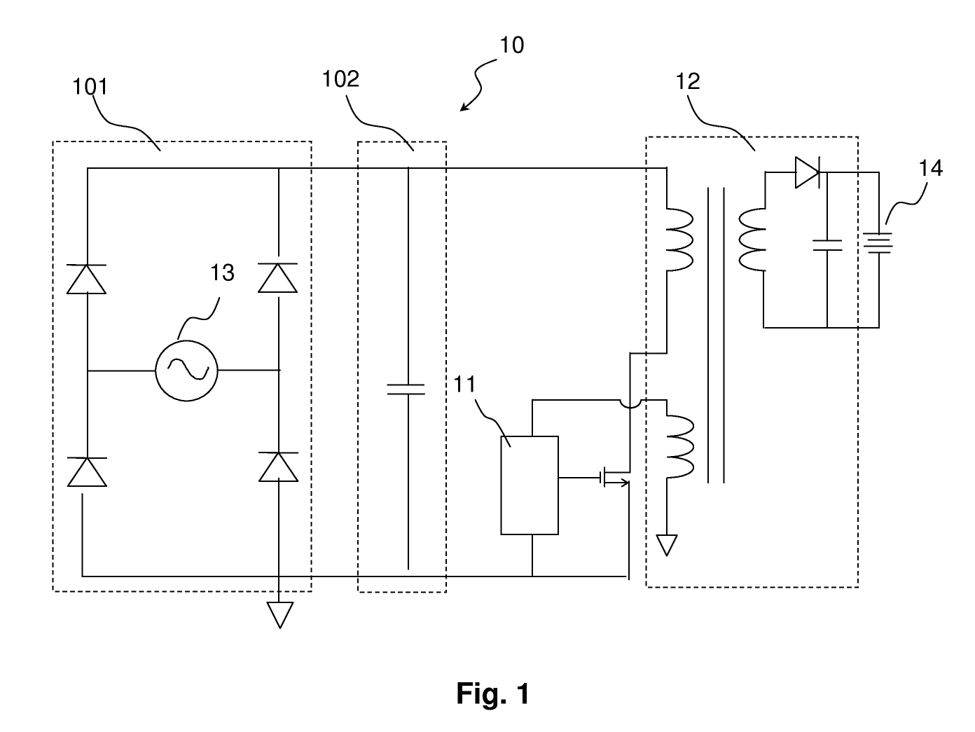

### DESCRIPTION OF THE PREFERRED EMBODIMENT

Intermittent load control methods and intermittent load charging devices are disclosed. In the following description, for purposes of explanation, numerous specific details are set forth in order to provide a thorough understanding of the embodiment of the invention. It is apparent, however, to one skilled in the art that the present invention may be practiced without these specific details or with an equivalent arrangement.

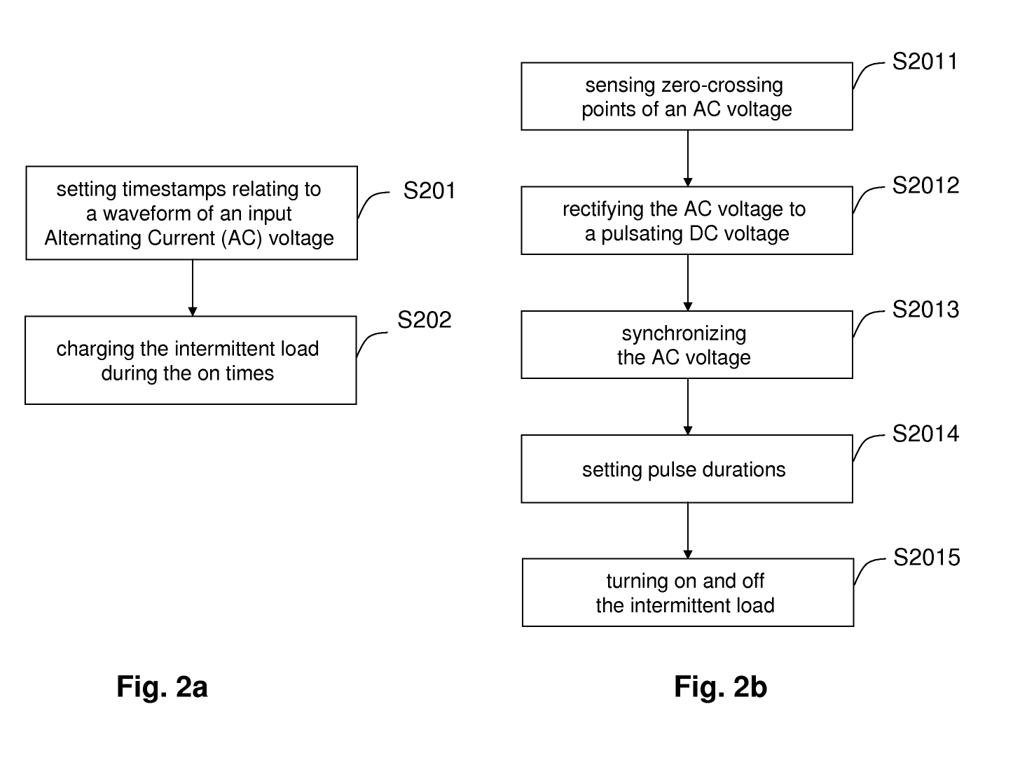

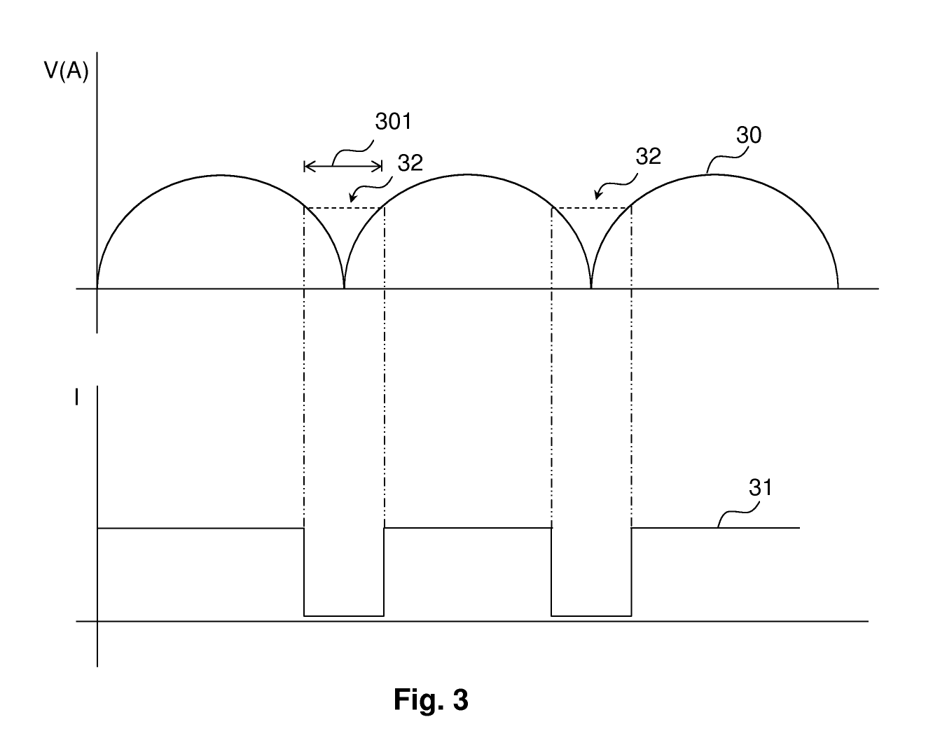

With reference to FIGS. 2a, 2b and 3, FIGS. 2a and 2b are flow charts of a method for charging an intermittent load in accordance with an embodiment of the present invention. FIG. 3 is an exemplary waveform diagram of an intermittent load in response to a rectified Alternating Current (AC) voltage and it's current. Intermittent loads, in the present disclosed embodiment, are defined as chargeable loads (batteries) or electronic devices that can be pulse triggered on and off periodically where the intermittent load's current can be interrupted without compromising its utility.

The method in accordance with the present invention for charging an intermittent load comprises S201 setting timestamps relating to a waveform of an input Alternating Current (AC) voltage. The timestamps are synchronized to the AC voltage and have on times and off times. As shown in FIG. 2a, the method further comprises S202 charging the intermittent load during the on times.

The timestamps synchronized to the AC voltage can be determined through, for instance, the measurement of the rectified AC voltage (i.e. the pulsating Direct Current (DC) voltage) associated with a controller connected to a rectifier, or measurement and comparison of the AC voltage before the rectifier. Accordingly, in step S201, the method further comprises acts of S2011 sensing zero-crossing points of a differential AC voltage, S2012 rectifying the AC voltage to a pulsating DC voltage, S2013 synchronizing the AC voltage, S2014 setting pulse durations and S2015 turning on and off the intermittent load.

Accordingly, when the zero-crossing point (i.e. 0 volt point) of the AC voltage or the pulsating DC voltage is sensed, the controller is able to set pulse durations by giving at least one falling time and at least rising time synchronized to frequencies of the AC voltage (e.g. line voltage is 120V/60 Hz in U.S., and 240-250V/50 Hz in Australia). The on times and the off times are directly related to the rising times and the falling times. The controller may then send an interrupt signal to turn the intermittent load on and off according to the given on time and off time.

As mentioned above in the background section, the electronic device requires a filter capacitor that withstands the high rectified voltage and holds a large enough charge to supply the required current to the load. As shown in FIG. 3, when the intermittent load has been turned off and as the pulsating DC voltage 30 approaches zero, no current 31 flows through the intermittent load, and no voltage drop 32 occurs during the off time period 301. Therefore, the capacitance of the filter capacitor used for the intermittent load can be successfully reduced since the voltage drop on the filter capacitor is now less than before.

Using smaller filter capacitors also has the benefit of increasing the power factor. In general, when a large capacitor used at the input of an electronic device, the current waveform does not follow the input voltage waveform in a linear fashion so the power factor is consequently quite low. The peak of the input current can be lowered dramatically when a smaller filter capacitor is in use, which has a beneficial effect on the power factor.

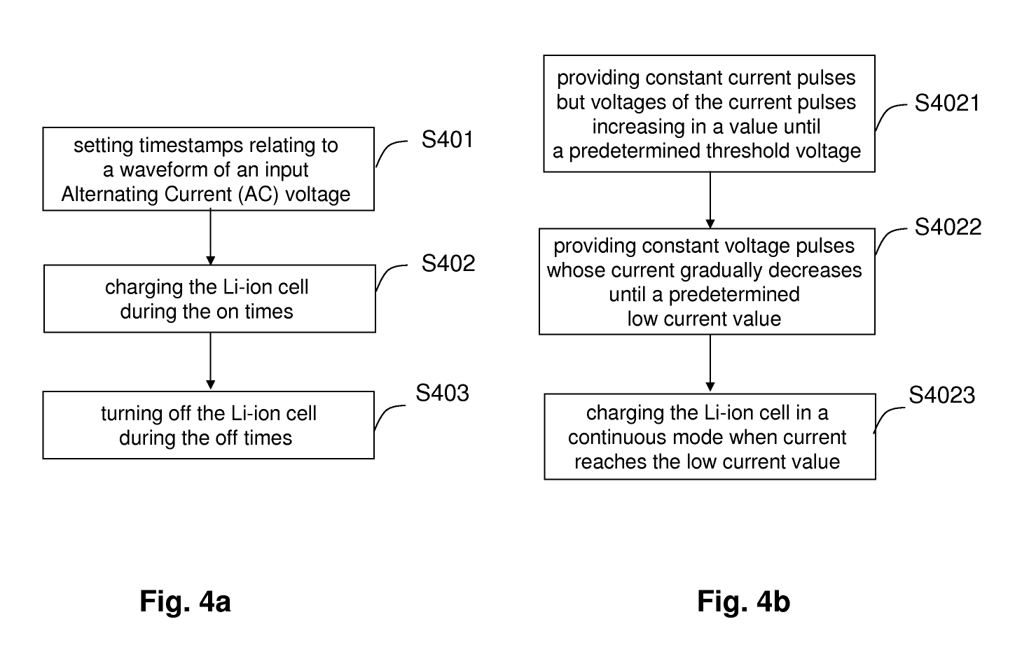

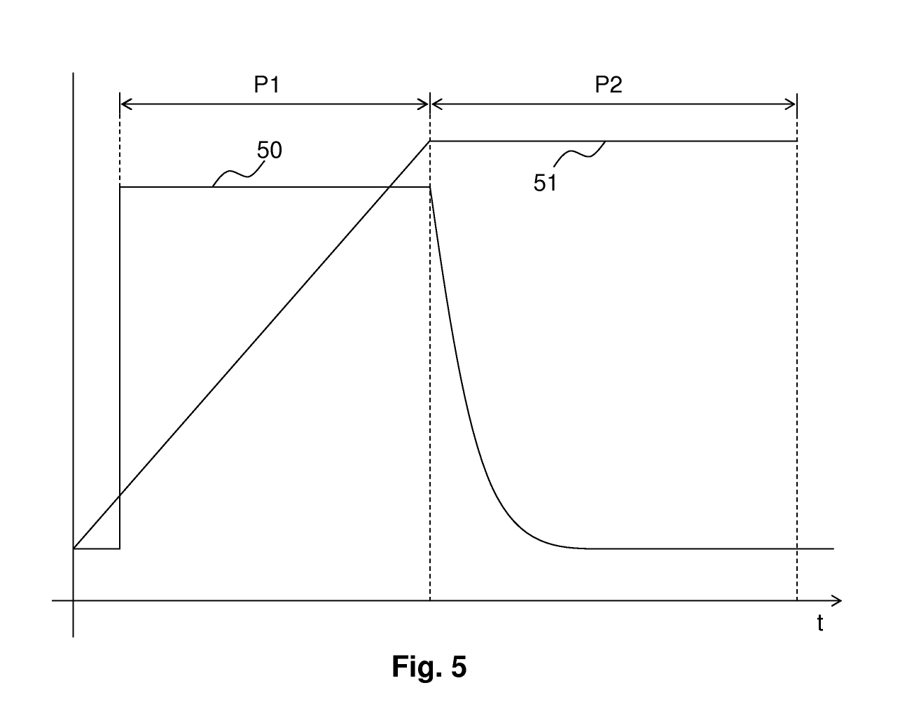

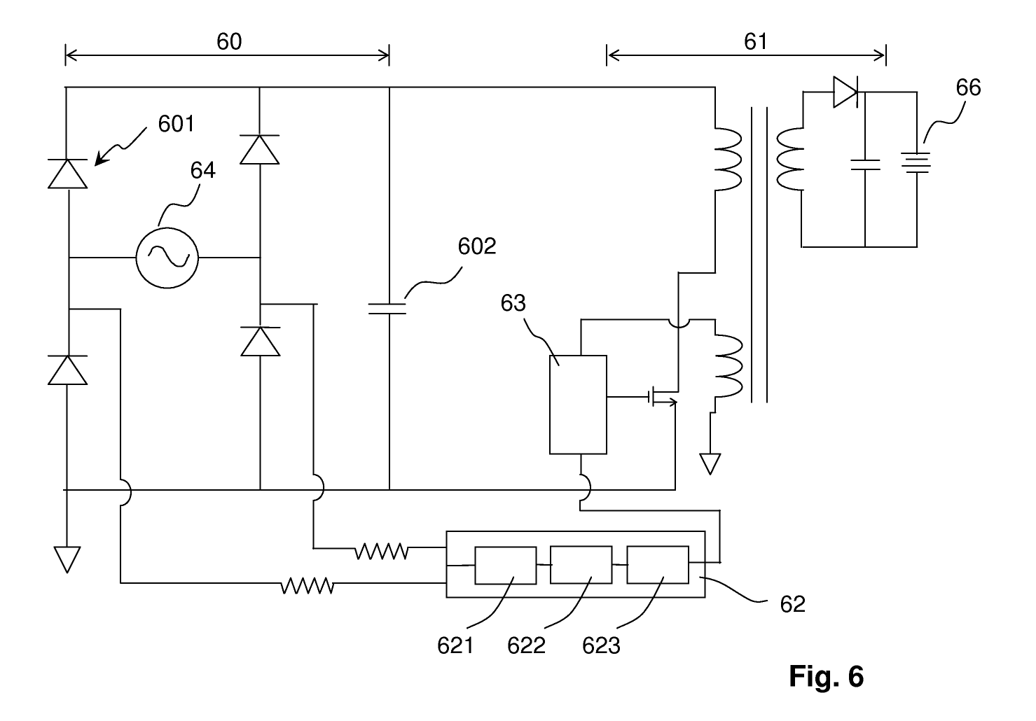

With reference to FIGS. 4a, 4b, 5 and 6, FIGS. 4a and 4b are flow charts of a method for charging a Lithium-ion (Li-ion) cell in accordance with an embodiment of the present invention. FIG. 5 illustrates an exemplary diagram of a typical charging curve for a Li-ion cell. FIG. 6 is an exemplary circuit diagram of a charging device in accordance with an embodiment of the present invention. The Li-ion cell can be pulse charged and the pulse charging can actually improve the Li-ion cell's operation and lifetime. The previously discussed method of FIGS. 2a and 2b of the present invention can be applied to a Li-ion cell.

Li-ion charging current and voltage curves shown in FIG. 5 consist of two portions. The first portion P1 is a constant current region wherein the voltage 51 continuously increases, and the charging current 50 is constant. The second portion P2 shows the current 50 decreasing in a non-linear relationship until a predetermined low value while the cell voltage is held constant.

In this embodiment, as shown in FIG. 4a, a method for charging a Li-ion cell comprises S401 setting timestamps relating to a waveform of an input Alternating Current (AC) voltage. The timestamps are synchronized to the AC voltage and have on times and off times. The method for charging a Li-ion cell further comprises S402 charging the Li-ion cell during the on times, and S403 turning off the Li-ion cell for charging during the off times. In order to comply with the Li-ion cell charging characteristics as shown in FIG. 5, the step S402, as shown in FIG. 4b, further comprises acts of S4021 providing constant current pulses but voltages of the current pulses increasing in a value until a predetermined threshold voltage, and S4022 providing constant voltage pulses whose current gradually decreases until a predetermined low current value.

In addition, using the method of this embodiment for charging a Li-ion cell can have the benefit of selectively switching from a pulsed mode (i.e. steps S4021 and S4022) to a continuous mode when the charging current of the Li-ion cell reaches the low current value. The continuous mode is defined as a charging current and voltage that are not turned on and off synchronous to an AC line voltage, which is known as the conventional charging method. In this manner, as the charging current reaches the low current value, it may be desired to change the charging mode from the pulsed mode to the continuous mode, because when the charging current becomes small, the demands on the filter capacitor are also reduced and a smaller size capacitor can still support a continuous, yet smaller, current.

Accordingly, after step S4022, the method for charging a Li-ion cell further comprises S4023 charging the Li-ion cell in a continuous mode when current reaches the low current value. However, it is noted that the pulsed mode operation can be used at anytime in any region of the charging curves as long as the controller can accept the changes in voltage without falsely triggering a fault condition.

As shown in FIG. 6, a circuit diagram of a charging device is disclosed. In this embodiment, the charging device comprises a filtering stage 60, a converter 61, an intermittent controller 62, and a charging controller 63. The filtering stage comprises a rectifier 601 and a filter capacitor 602. The rectifier 601 connects to an AC voltage power source 64, which converts an AC voltage to a pulsating DC voltage. The filter capacitor 602 is connected to the rectifier 601 for sustaining voltages when the pulsating DC voltage approaches zero.

The converter 61 is connected to the filter capacitor 602 and an intermittent load 66, and has output means for accepting the intermittent load 66 to be charged. In this example, the intermittent load 66 may be a Li-ion cell. The converter may be a flyback transformer.

The intermittent controller 62 is connected to the AC voltage power source 64 and the rectifier 601, and generates an interrupt signal that is synchronized with the AC voltage. The intermittent controller 62 comprises a zero-crossing sensor 621 (e.g., a differential amplifier), a phase-locked loop (PLL) circuit 622, and a duty cycle selector 623. The operations of intermittent controller 62 for generating the interrupts have been mentioned in the above steps S401 to S403.

The zero-crossing sensor 621 is connected to the AC power source 64 and the rectifier 601 and senses zero-crossing points of an AC voltage. The PLL circuit 622 is connected to the zero-crossing sensor 621 and generates a clock signal synchronized to the AC voltage. The duty cycle selector 623 is connected to the PLL circuit 622 and the charging controller 63, and outputs the interrupt signal that is formed by giving pulse durations to the clock signal. Accordingly, the interrupt signal can be a Pulse-Width Modulation (PWM) signal.

The charging controller 63 is connected to the filter capacitor 602, the converter 61 and the intermittent controller 62. The charging controller 63 provides a regulating charging control for the converter 61, and accepts the interrupt from the intermittent controller 62 that turns the intermittent load 66 on and off. In this example, the charging controller 63 is a primary side flyback controller. The primary side flyback controller allows all the charging functions to be controlled from the primary side of the converter 61, and there is no need for feedback from the secondary side. However, this is just an example, the offline solutions that require secondary side feedback can also be easily implemented. The regulating charging control 63, mentioned in above steps S4021 to S4023, controls charging current and voltage that comply with the charging characteristics of the intermittent load 66 (i.e., the characteristics of the Li-ion cell shown in FIG. 5).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for charging an intermittent load comprising:
setting timestamps relating to a waveform of an input Alternating Current (AC) voltage, wherein the timestamps are synchronized to the AC voltage and comprises on times and off times that turn the intermittent load off and on; and
charging the intermittent load during the on times.

2. The method as claimed in claim 1, wherein the step of setting timestamps further comprises acts of:
sensing zero-crossing points of the AC voltage;
rectifying the AC voltage to a pulsating Direct Current (DC) voltage;
synchronizing the AC voltage;
setting pulse durations; and
turning on and off the intermittent load.

3. The method as claimed in claim 2, wherein the pulse duration is given by at least one falling time and at least one rising time based on frequencies of the AC voltage, and the on times and the off times are directly related to the rising times and the falling times.

4. A method for charging a Lithium-ion cell comprising
setting timestamps relating to a waveform of an input AC voltage, wherein the timestamps are synchronized to the AC voltage and have on times and off times;
charging the Lithium-ion cell during the on times; and
turning off the Lithium-ion cell for charging during the off times.

5. The method as claimed in claim 4, wherein the step of charging the Lithium-ion cell during the on times comprises acts of
providing constant current pulses but voltages of the current pulses increasing in a value until a predetermined threshold voltage; and
providing constant voltage pulses whose current gradually decreases until a predetermined low current value.

6. The method as claimed in claim 5, wherein the step of charging the Lithium-ion cell during the on times further comprises an act of charging the Lithium-ion cell in a continuous mode when current reaches the predetermined low current value.

7. A charging device comprising
a filtering stage comprising
a rectifier being connected to an AC voltage power source and converting an AC voltage to a pulsating DC voltage; and
a filter capacitor being connected to the rectifier for sustaining voltages when the pulsating DC voltage approaches zero;
a converter being connected to the filter capacitor and an intermittent load, and having output means for accepting the intermittent load to be charged,
an intermittent controller being connected to the AC voltage power source and the rectifier, and generating an interrupt signal that is synchronized with the AC voltage; and
a charging controller being connected to the filter capacitor, the converter and the intermittent controller, providing a regulating charging control for the converter, and accepting the interrupt signal from the intermittent controller that turns the intermittent load on and off.

8. The charging device as claimed in claim 7, wherein the intermittent load is a Lithium-ion cell.

9. The charging device as claimed in claim 7, wherein the converter is a flyback transformer and the charging controller is a primary side flyback controller.

10. The charging device as claimed in claim 7, wherein the intermittent controller comprises
a zero-crossing sensor, for sensing when the differential AC voltage is zero;
a phase-locked loop circuit, for generating a clock signal synchronized to the AC voltage; and
a duty cycle selector, for outputting the interrupt signal to the charging controller, wherein the interrupt signal is formed by giving pulse durations to the clock signal.
